(19) United States
(12) Patent Application Publication
(10) Pub. No.: US 2017/0308606 A1
(43) Pub. Date: Oct. 26, 2017

(54) SYSTEMS AND METHODS FOR USING A STRUCTURED QUERY DIALECT TO ACCESS DOCUMENT DATABASES AND MERGING WITH OTHER SOURCES

(71) Applicant: Quest Software Inc., Aliso Viejo, CA (US)

(72) Inventors: Jan Henrik Jonsson, Long Beach, CA (US); Kieron Spencer Briggs, Brunswick East (AU); Gregory John Cottman, Wantirna South (AU); Aleksey Mikhailovich Bazhenov, Mission Viejo, CA (US)

(73) Assignee: Quest Software Inc., Aliso Viejo, CA (US)

(21) Appl. No.: 15/136,505

(22) Filed: Apr. 22, 2016

(51) Int. Cl. G06F 17/30

(52) U.S. Cl. CPC G06F 17/30604; G06F 17/30598; G06F 17/30315; G06F 17/30339

(57) ABSTRACT

Disclosed are systems and methods that allow a database engine to access a non-relational document database and dynamically apply a schema that maps documents comprising semi-structured data into a relational data structure. In embodiments, mapping may be accomplished by parsing and analyzing a set of sample documents to empirically generate a normalized tabular schema. In embodiments, the schema accommodates format evolution and variability of documents having different structures and different sets of attributes is automatically executed in a background process without requiring user involvement. This normalization process eliminates the need to create unique modeling languages for semi-structured data. In embodiments, an SQL dialect may be used to join query results and combine the resulting document data with tables from different dimensional or relational databases to generate a combined result without the need to create additional temporary tables for non-conforming documents.

### BACKGROUND

### A. Technical Field

The present invention relates to databases and, more particularly, to systems, devices, and methods of executing queries, e.g., a Structured Query Language (SQL) queries, against a document or non-relational database, or against both relational and document databases.

### B. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Relational databases, such as SQL databases, that use SQL as a query language for accessing and searching, typically represent data in a tabular structure. An emerging generation of document database systems instead uses flexible document formats that contain semi-structured data. The flexible formats contain embedded structures, such as nested sub-documents and arrays that differ significantly from the inherent schema provided by the tabular data format of relational databases, where tables have a defined schema that specifies the number columns and the data types of columns, etc., and where every element of data strictly complies with that schema.

While as objects in document databases, in contrast, need not conform to existing a predefined schema, one major drawback of document databases is the lack of tools for accomplishing useful tasks, such as data query, backup management, and replication. Another drawback of document database systems is that they oftentimes use specialized query language that prevents joining query results with industry standard relational databases. In fact, most document databases are accessed through an API rather than through a language. Some document databases, such as MongoDB, provide a SQL-like language. These specialized query languages, however, are relatively difficult, not standardized, and cumbersome to apply. As a result, each document database that has its own dialect suffers from the inability of employing industry standard SQL to run queries on nested documents that cannot be simply mapped into a single tuple.

For example, in order to discover the data model of a non-relational MongoDB database, the data in the collections must be read and analyzed to empirically derive a schema. This is problematic for large tables that may contain millions of rows, because exhaustive analysis of such a collection would be prohibitively slow for a dynamic process that would cause an unacceptable wait time for the end-user. Also, unlike the rows of a relational database table, the format of documents in a single MongoDB collection is capable of evolving over time such that documents subsequently added to the database may contain new fields and sub-documents that are different from those already in the collection, thereby, adding another layer of complication.

Accordingly, what is needed are systems and methods that allow document databases to be queried using typical relational query languages to better combine query results from relational and document databases.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that this is not intended to limit the scope of the invention to these particular embodiments.

FIG. (“FIG.”) 1 illustrates an exemplary relational data model generated from two JSON (JavaScript Object Notation) documents in a collection, according to various embodiments of the present disclosure.

FIG. 2A is a flowchart of an illustrative process for generating a relational data model from documents in a non-relational document database, according to various embodiments of the present disclosure.

FIG. 2B is a flowchart of an illustrative process for using a relational data model to access documents in a non-relational document database via a relational database query, according to various embodiments of the present disclosure.

FIG. 3A illustrates an exemplary SQL query of all salespeople in the documents used to generate the relational model in FIG. 1, according to various embodiments of the present disclosure.

FIG. 3B illustrates an exemplary resulting output for a direct SQL query of a sub-table, according to various embodiments of the present disclosure.

FIG. 3C illustrates an exemplary SQL query that joins tables into a more complex set of results, according to various embodiments of the present disclosure.

FIG. 3D illustrates the resulting output of the query shown in FIG. 3C, according to various embodiments of the present disclosure.

FIG. 3E illustrates exemplary salesperson data, according to various embodiments of the present disclosure.

FIG. 3F illustrates an exemplary SQL query that allows to query salespersons' monthly salary, according to various embodiments of the present disclosure.

FIG. 3G illustrates the resulting output of the query shown in FIG. 3F, according to various embodiments of the present disclosure.

FIG. 4 and FIG. 5 are flowcharts of exemplary processes for generating a relational schema that separates repeating elements into their own tables with FIG. 5 illustrating the recursive portion of the process in FIG. 4, according to various embodiments of the present disclosure.

FIG. 6 is a flowchart of an illustrative process for generating a document database (e.g., MongoDB) query, according to various embodiments of the present disclosure.

FIG. 7 and FIG. 8 are flowcharts of an illustrative process for tabulating MongoDB result documents with FIG. 8 illustrating the recursive portion of the process in FIG. 7, according to various embodiments of the present disclosure.

FIG. 9 depicts a block diagram of an exemplary information handling system according to embodiments of the present invention.

### DETAILED DESCRIPTION

In the following description, for the purpose of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Those skilled in the art will also recognize that additional modifications, applications, and embodiments are within the scope thereof, as are additional fields in which the invention may provide utility. Accordingly, the embodiments described below are illustrative of specific embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearance of the phrase “in one embodiment,” “in an embodiment,” or the like in various places in the specification are not necessarily referring to the same embodiment.

Furthermore, connections between components or between method steps in the figures are not restricted to connections that are affected directly. Instead, connections illustrated in the figures between components or method steps may be modified or otherwise changed through the addition thereto of intermediary components or method steps, without departing from the teachings of the present invention.

In this document, for purposes of illustration, MongoDB is used as a specific type of document, or NoSQL, database; however, this is not intended as a limitation on the scope of the present invention. The embodiments of the invention may be applied to any other document database, such as Couchbase or DocumentDB. The term “document” generally refers to a document or record and its associated data within a database and may be any object that contains a list of key-value pairs, wherein each key is a string and the value is either another object, an array (i.e., a list of objects), or a simple value that may be a string or a number. The term document further comprises the structure of data within a document or record. For instance, two documents that comprise the same data in different internal structures would not be considered identical documents.

MongoDB is a document database that stores data records in JSON documents. JSON, like XML, is a self-describing flexible document format with semi-structured data where the data is tagged with labels so that any program can read it by examining a label and the value associated with that label. In terms of traditional relational data modeling, a MongoDB document represents a single instance of a high-level entity, and may contain nested instances of other subordinate or related entities. The document instances of the same high-level entity are grouped together into MongoDB collections, which are somewhat analogous to relational tables. A document is what software developers call an object. This type of object contains a list of key value pairs, where each key is a string and the value is either another object, an array of objects, or a simple value this is a string or number.

For example, the following collection contains two documents that describe sales people and their sales over time:

{

SalesPersonId: 1,
StartDate: “2012-01-01”,
AvailableProducts: [ “A”, “B”],
Sales: [

{

“Month”: “2012-01-01”,
“Products”: [

{ “Product”: “A”, “Gross”: 2981, “Commission”: 48},
{ “Product”: “B”, “Gross”: 1546, “Commission”: 64}

]

},
{

“Month”: “2012-02-01”,
“Products”: [

{ “Product”: “A”, “Gross”: 8466, “Commission”: 59}

]

},
{

“Month”: “2012-04-01”,
“Products”: [

{ “Product”: “A”, “Gross”: 1400, “Commission”: 44},
{ “Product”: “B”, “Gross”: 6419, “Commission”: 91}

]

},
{

“Month”: “2012-05-01”,
“Products”: [

{ “Product”: “A”, “Gross”: 5777, “Commission”: 29}

]

},
{

“Month”: “2012-07-01”,
“Products”: [

{ “Product”: “A”, “Gross”: 3672, “Commission”: 16},
{ “Product”: “B”, “Gross”: 7994, “Commission”: 76}

]

},
{

“Month”: “2012-08-01”,
“Products”: [

{ “Product”: “A”, “Gross”: 3331, “Commission”: 51}

]

},
{

“Month”: “2012-10-01”,
“Products”: [

{ “Product”: “A”, “Gross”: 1024, “Commission”: 10},
{ “Product”: “B”, “Gross”: 3634, “Commission”: 6}

]

},
{

“Month”: “2012-11-01”,
“Products”: [

{ “Product”: “A”, “Gross”: 4564, “Commission”: 98}

]

}

]

},
{

SalesPersonId: 2,
StartDate: “2012-02-01”,
AvailableProducts: [ “A”, “B”],
Sales: [

{

“Month”: “2012-02-01”,
“Products”: [

{ “Product”: “B”, “Gross”: 1799, “Commission”: 77}

]

},
{

“Month”: “2012-03-01”,
“Products”: [

{ “Product”: “A”, “Gross”: 8431, “Commission”: 76},
{ “Product”: “B”, “Gross”: 909, “Commission”: 22}

]

},
{

“Month”: “2012-05-01”,
“Products”: [

{ “Product”: “B”, “Gross”: 3190, “Commission”: 33}

]

},
{

“Month”: “2012-06-01”,
“Products”: [

{ “Product”: “A”, “Gross”: 8941, “Commission”: 8},
{ “Product”: “B”, “Gross”: 3189, “Commission”: 22}

]

},
{

“Month”: “2012-08-01”,
“Products”: [

{ “Product”: “B”, “Gross”: 3932, “Commission”: 55}

]

},
{

“Month”: “2012-09-01”,
“Products”: [

{ “Product”: “A”, “Gross”: 7569, “Commission”: 91},
{ “Product”: “B”, “Gross”: 9692, “Commission”: 88}

]

},
{

“Month”: “2012-11-01”,
“Products”: [

{ “Product”: “B”, “Gross”: 5988, “Commission”: 68}

]

},
{

“Month”: “2012-12-01”,
“Products”: [

{ “Product”: “A”, “Gross”: 9143, “Commission”: 11},
{ “Product”: “B”, “Gross”: 1429, “Commission”: 25}

]

}

]

}

Each document in the collection complies with standard JSON formatting and comprises information regarding a sales person and various sale events occurring on certain dates and associated with that sales person. It is noted that the documents represent the data contained therein; however, a document is not intrinsic to the data it contains. Each document comprises fields that contain a label and a value component. The fields labeled SalespersonId and StartDate are defined as single-value fields that represent a sales person and respective start date. The value of the field labeled SalespersonId has a numeric value, whereas the value of field labeled StartDate has the datatype of string, as indicated by double quotes. The numeric value of the field Salespersonid serves as a key that uniquely identifies each document in a database.

AvailableProducts and Sales are examples of fields and sub-documents defined as multi-value sub-elements. Sub-documents have their own identifiers or keys; e.g., the AvailableProducts field contains an array of two values that represent two products, A and B. Sales, which describes a summary of sales events that occurred, is not defined as an array, but rather may be considered a sub-document that has its own embedded sub-elements: the field Month having a value that is of the datatype date, and the filed Products that consists of an array of two or more values. Each array has three fields: Product, Gross, and Commission that contain no further sub-elements.

For comparison, it is noted that, according to the notational standards of JSON documents, sub-element AvailableProducts would be referred to as an “array of values” and sub-element Sales would be referred to as an “array of anonymous documents.” Based on the format restrictions of JSON documents, arrays are bounded by square brackets, strings are bounded by double quotes, and sub-elements are bounded by braces that may have arbitrary content.

One of skill in the art will understand that the data in a document database is not suitable for direct mapping into relation tables such that regular SQL operations cannot be applied to a document database holding the JSON documents. Neither can a document database be simply joined with other databases, in particular, with relational databases. Therefore, it would be desirable to convert the data in a document database from its document representation into a format that is equivalent to a relational model.

It is noted that several differences exist between document models and relational models. The principal difference being that relational models use foreign key relationships between tables to reference subordinate or related tables, rather than embedding related tables as sub-documents as in, e.g., a MongoDB document database. Therefore, in a relational model, a single document may produce at least one table; however, when converted into a relational model, the single document may translate into several tables, such as the relational tabular format of SalesPerson documents shown in FIG. 1 that, according to various embodiments of the present disclosure, illustrates an exemplary relational data model generated from two JSON documents in a collection. The number of the tables that are created depends on the number of repeating elements or sub-documents. For example, relational model 100 generated from the two example documents that are discussed with respect paragraph 25 may comprise four relational tables 102, 110, 120, and 130 shown in FIG. 1.

In accordance with embodiments of the present disclosure, following the guidelines of database normalization, in an initial discovery phase that samples various documents to identify common elements that occur across the majority of the documents and to discover the data model of a document database, the structure of the documents is automatically analyzed for fields and sub-documents to generate a schema for each document. Then, in embodiments, the schemas may be merged into an aggregate or global schema that represents all the documents in the sample. A target structure that resembles a normalized relational schema is created and, finally, the documents are mapped onto that target structure, as will be discussed in detail further below. This schema generation and mapping into the resulting target structure creates an interface that bridges the gap between the tabular data in common SQL databases and the flexible document formats used in document databases to allow document databases to be manipulated using, e.g., regular SQL queries.

In embodiments, mapping is performed in real time, such that no conversion of the entire document database into the relational database is necessary. Instead, once the document discovery phase is completed, the data in the document database is queried in place and without first making a copy of the entire document database. In embodiments, this is accomplished by storing a normalization as a configuration and then dynamically applying the configuration to the document data. It is understood that after initial schema generation, a user may have the option to adjust parameters.

In embodiments, if objects that are stored in relational table 102, 110, 120, 130 in FIG. 1 are similar, i.e., the objects generally have the same key-value pairs, one column of a relation table may be used for each key. Each array may be represented by a second table that holds a foreign key that relates back to a parent table. In embodiments, a synthetic key column is generated in the relation table in order to specify the individual objects of an array. The synthetic key may be a monotonically increasing number that identifies the first record as record #1, the second record as record #2, etc.; similar to synthetic keys in relational tables that lack a natural key in the data that could otherwise uniquely identify a record. In embodiments, if an array contains a simple value that does not exist in the original document, a name for that value may be generated.

In detail, relational model 100 is a schema or structure that illustrates how the data in JSON documents may be mapped to or organized as relational data tables 102, 110, 120, 130 of a normalized relational database. Each document is represented by a row in SalesPerson table 102 that comprises two fields, Salespersonld 104 and StartDate 106, that are processed. When the related sub-table Salesperson AvailableProducts 110 is created, value column 116 may be added to hold, as an example, the values A and B. In embodiments, a synthetic key, called AvailableProducts_Key 114, that comprises link 118 pointing back to Salesperson table 102 is added. The synthetic key used for the array may comprise, as the first element, a numeric 1 and, as the second element, a number 2 to provide table 110 with a unique key.

As previously noted, sub-element Sales in the JSON documents is not an array, but rather a sub-document that comprises its own sub-elements, and the sub-element Products is an array that comprises repeating values A and B. Therefore, in embodiments, to avoid repeating elements a multi-level target structure is generated that separates the repeating elements into two or more entities that comprise no repeating elements. In embodiments, the data is mapped into tables that conform to the First Normal Form, i.e., that do not contain repeating values.

For example, to avoid repeating elements, i.e., values that are in an array, in a table, the sub-element/array Products within the Sales sub-element/array in the JSON documents is modeled as a row in its own table SalesPerson_Products 130 that is distinct and separate from SalesPerson_Sales table 120 that contains sub-element Month 126. Sub-table SalesPerson_Products 130 further comprises the three sub-element fields Product 140, Gross 142, and Commission 144 with the appropriate data types found in the JSON documents. Because the sub-element Products is represented as an array, integer values are used to identify the elements Month and Products in the Sales array, i.e., the sales numbers and the corresponding month.

In embodiments, since the Products sub-element within the Sales sub-element has two levels of nesting, sub-table SalesPerson_Products 130 is created comprising primary keys SalesPersonid 132, Sales_Key 134, and Products_Key 136. Each key 132-136 relates back to its respective sub-element and is a numeric array index that uniquely identifies each row in table 130. Products_Key 136 identifies rows in sub-table SalesPerson_Products 130, whereas SalesPersonid 132 and Sales_Key 134 are foreign keys that may identify rows in other tables they link to.

Overall the relational data tables 102, 110, 120, 130 that are created provide a normalized relational view of a non-relational database, such as MongoDB. The combination of columns within tables allows to uniquely identify each individual row in a table. In embodiments, using the SQL feature of foreign keys allows to join elements from rows in two or more tables that could otherwise not be achieved, e.g., with MongoDB.

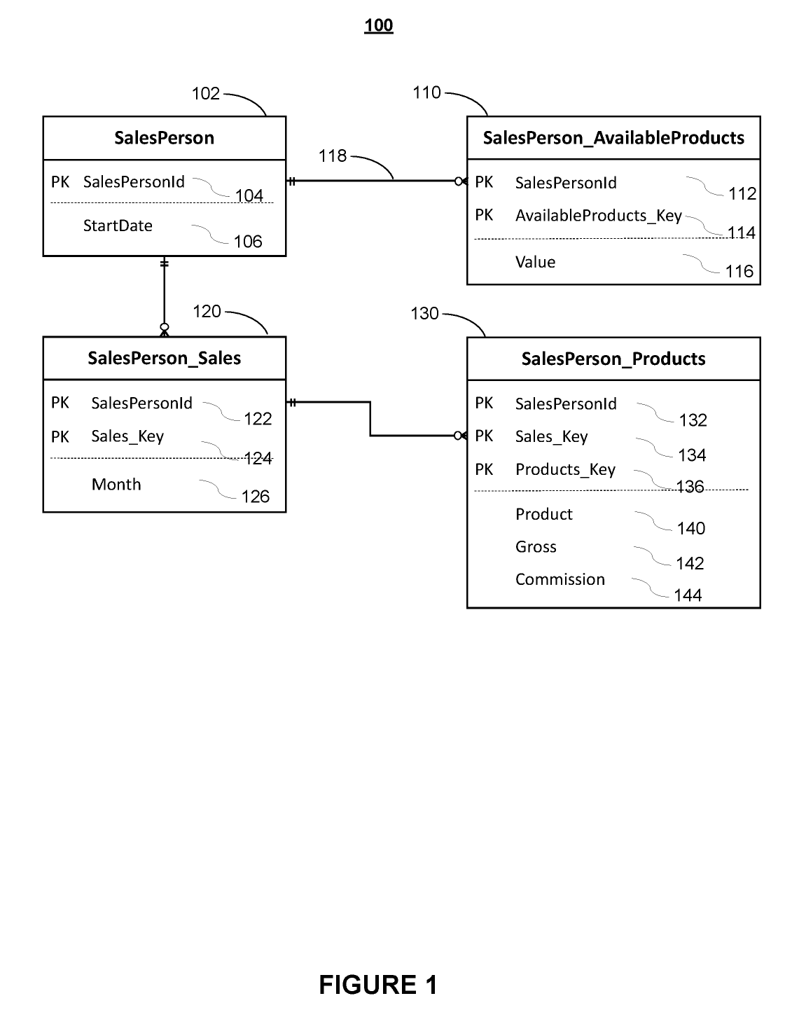

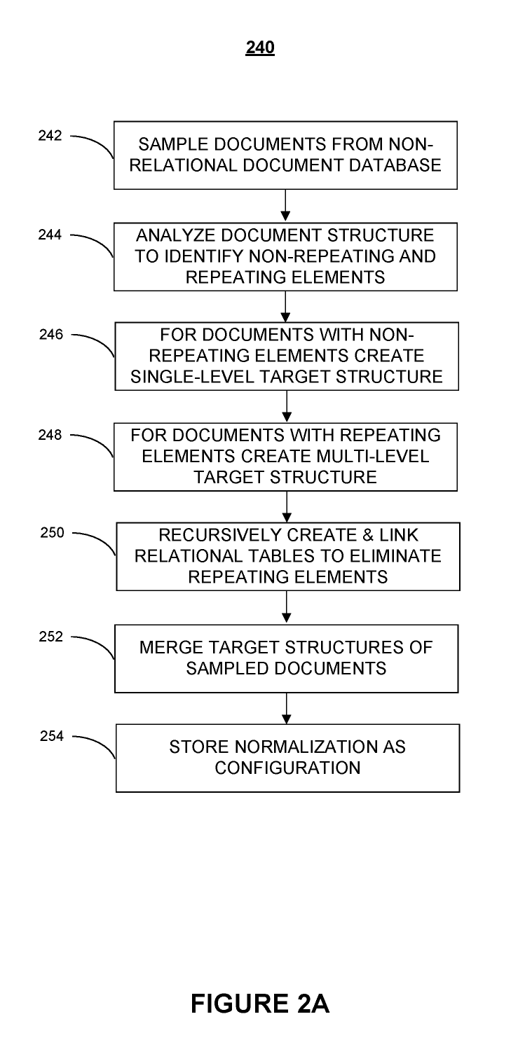

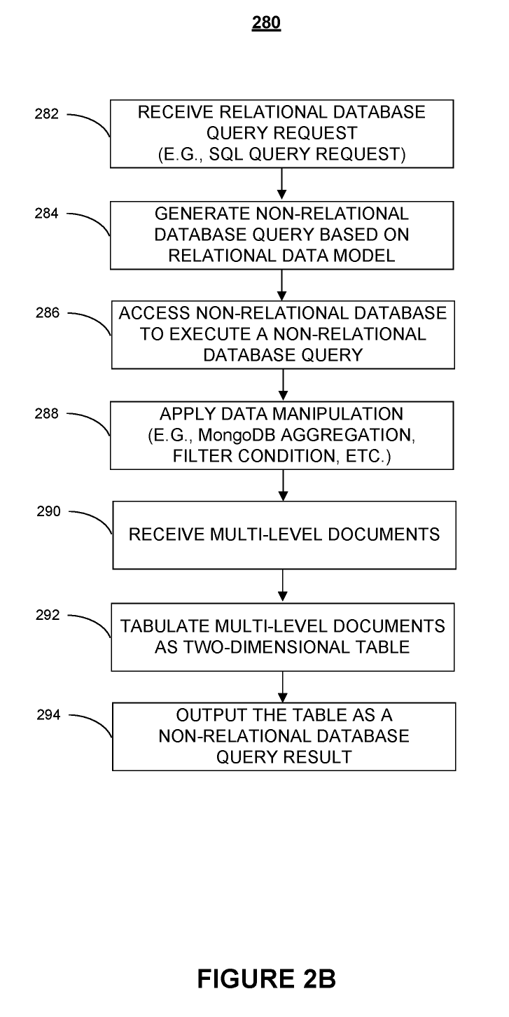

FIG. 2A is a flowchart of an illustrative process for generating a relational data model from documents in a non-relational document database, according to various embodiments of the present disclosure. The process for generating to generating a relational database begins at step 242 when documents are sampled from a non-relational database.

At step 244, the structures of the documents are analyzed to identify repeating and non-repeating elements.

At step 246, if the document or the element comprises non-repeating elements, a single-level target structure, e.g., a top-level table, is created.

At step 248, if the document or the element comprises repeating elements, a multi-level target structure, e.g., a sub-level table, is created.

At step 250, relational tables and/or sub-tables are recursively created and linked until the multi-level target structure no longer contains any repeating elements. In this manner, the tables maybe normalized.

At step 252, optionally, the target structures of the sampled documents are merged.

At step 254, optionally, the normalization of the tables may be stored as a configuration. Once a relational model is created, it may be used to access documents in a non-relational document database, for example, via a relational document database query, such as a SQL query. It will be appreciated by those skilled in the art that fewer or additional steps may be incorporated with the steps illustrated herein without departing from the scope of the invention. No particular order is implied by the arrangement of blocks within the flowchart or the description herein.

FIG. 2B is a flowchart of an illustrative process for using a relational data model to access documents in a non-relational document database via a relational database query, according to various embodiments of the present disclosure. The process begins at step 282 when a relational database query request, e.g., a SQL query request, is received.

At step 284, a non-relational database query, e.g., a MongoDB query, is generated, based on a relational data model such as dynamic relational data model.

At step 286, the non-relational database is accessed to execute the MongoDB query.

At step 288, optionally, the query is manipulated, for example, by applying filtering conditions to the MongoDB query.

At step 290, multi-level documents are received and tabulated, at step 292, as a two-dimensional table.

Finally, at step 294, the table is output as a MongoDB query result.

As an example, once relational model is generated from the documents in a non-relational database, e.g., a MongoDB database, the industry standard language SQL may be used to query the data in the documents, such as “all sales people,” via the following exemplary SQL query:

SELECT * FROM SalesPerson

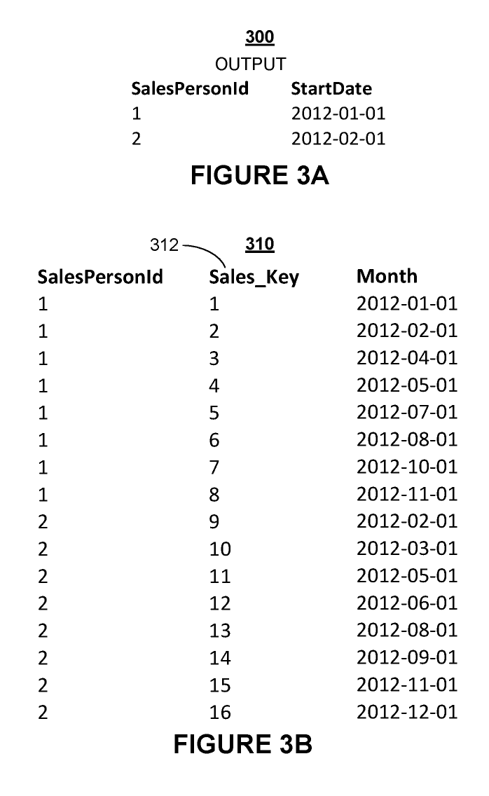

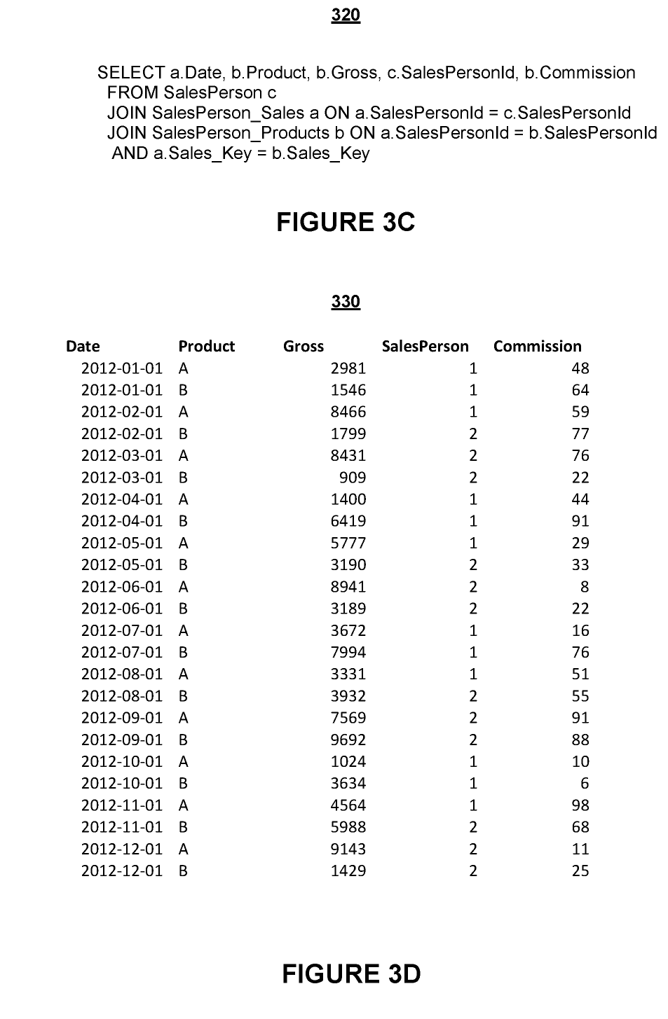

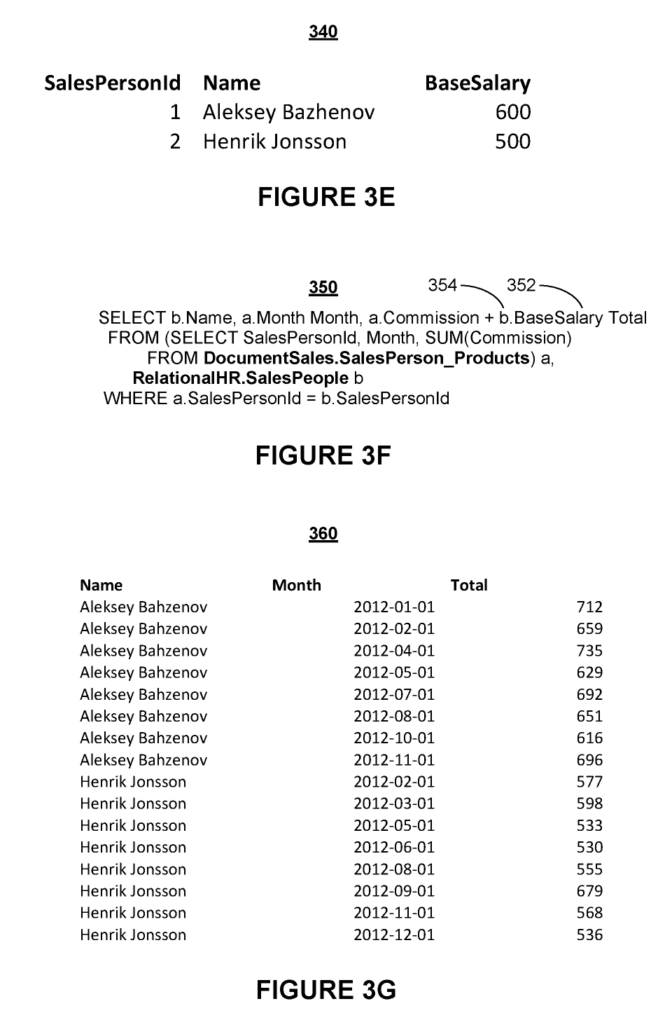

This query would yield output 300 shown in FIG. 3A.

In embodiments of the present invention, a query may be applied to a sub-table. For example, the query SELECT * FROM SalesPerson_Sales would yield result 310 shown in FIG. 3B that illustrates a resulting output for a direct SQL query of a sub-table, according to various embodiments of the present disclosure. One skilled in the art will appreciate that the generated column Sales_Key 312 should be unique, but the actual value may vary based on the specific implementation.

FIG. 3C illustrates an exemplary SQL query that joins tables into a more complex set of results, according to various embodiments of the present disclosure. In embodiments, a SQL query may join two or more tables to produce a more complex set of results that may yield more or more specific information. FIG. 3D illustrates the resulting output 330 of query 320 shown in FIG. 3C, according to various embodiments of the present disclosure.

In embodiments, once the document data is in a normalized relational form mapped onto a number of two-dimensional tables, using the steps detailed above, the mapped data may be joined with two or more tables from either another dimensional database or a traditional relational database that has undergone the mapping/normalization process previously described to exist in table format. In embodiments, the SQL join operator may be used to join the data sets across two or more databases.

Assuming that for example the Sales table is defined in a connection called DimensionalSales and another relational database called RelationalHR contains the table SalesPeople comprising data 340 shown in FIG. 3E, then the above method would allow to query each salesperson's monthly salary using expression 350 given in FIG. 3F. This query would generate result 360 shown in FIG. 3G. Each table name 352 in FIG. 3F is prefaced with its associated connection 354. In embodiments, the application executing them comprises a dictionary that allows to look up the full connection properties for each connection 354 used in the query.

It is understood that the systems and methods disclosed herein extend to joining multiple heterogeneous dimensional data sets, regardless of type. The systems and methods further extend to joining more heterogeneous environments, that allow to join data from, e.g., MongoDB, DocumentDB, OBIEE, Microsoft Analysis Service, Oracle, and MySQL in a single query to directly or indirectly generate the sought after final result. It is noted that typical NoSQL databases that merely have key-value pairs and a number of fields associated with those keys would not be compatible with this approach.

Converting data from a JSON-like document into a relational format involves sampling the data and deriving a schema. In embodiments, a sample of a MongoDB collection is read in batches to create a chronological spread of documents that accommodates evolving document formats, e.g., when documents that are added halfway through a collection or sample contain new sub-elements and fields. For example, a sample of 1,000 records may be read from a collection in batches of 250 records, where the first batch being read at the start of the collection, the second batch being read at the 50^{th} percentile of the volume, the third batch being read at the 75^{th} percentile, and the last batch being read at end of the collection. This sampling mechanism creates a chronologically diverse sample over the evolution of the collection.

In embodiments, in order to empirically derive a schema, the data in the sample is analyzed for fields and sub-documents in each document so that a single, normalized, relational schema is generated that collectively describes the sample documents. In embodiments, by moving sub-documents or repeating values to their own tables to produce a schema the relational model is taken to First Normal Form. It is noted that because second normal form and third normal form would require understanding of the values stored in each attribute, and whether those attributes depend upon a subset of the table key or other non-prime attributes within the table, automation remains challenging.

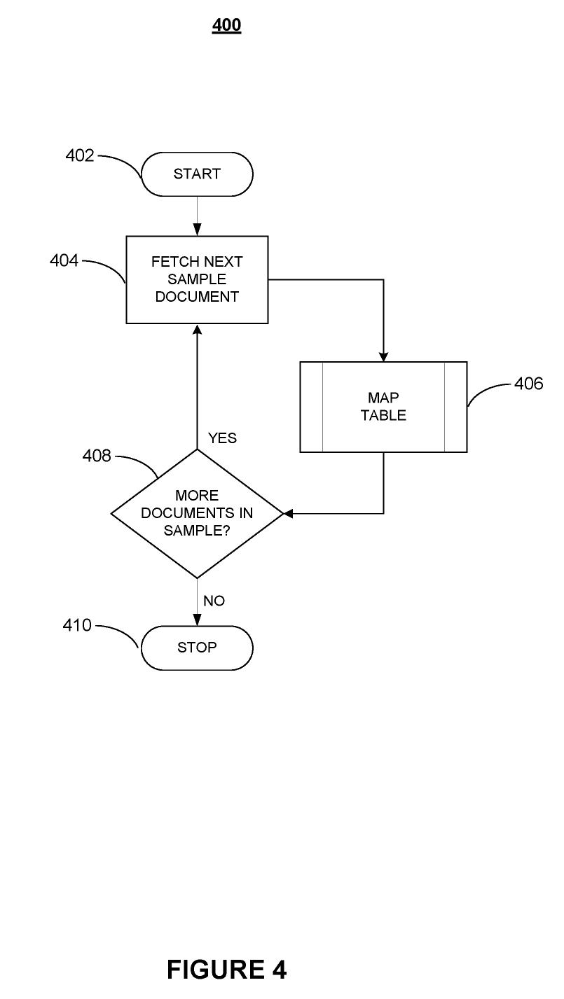

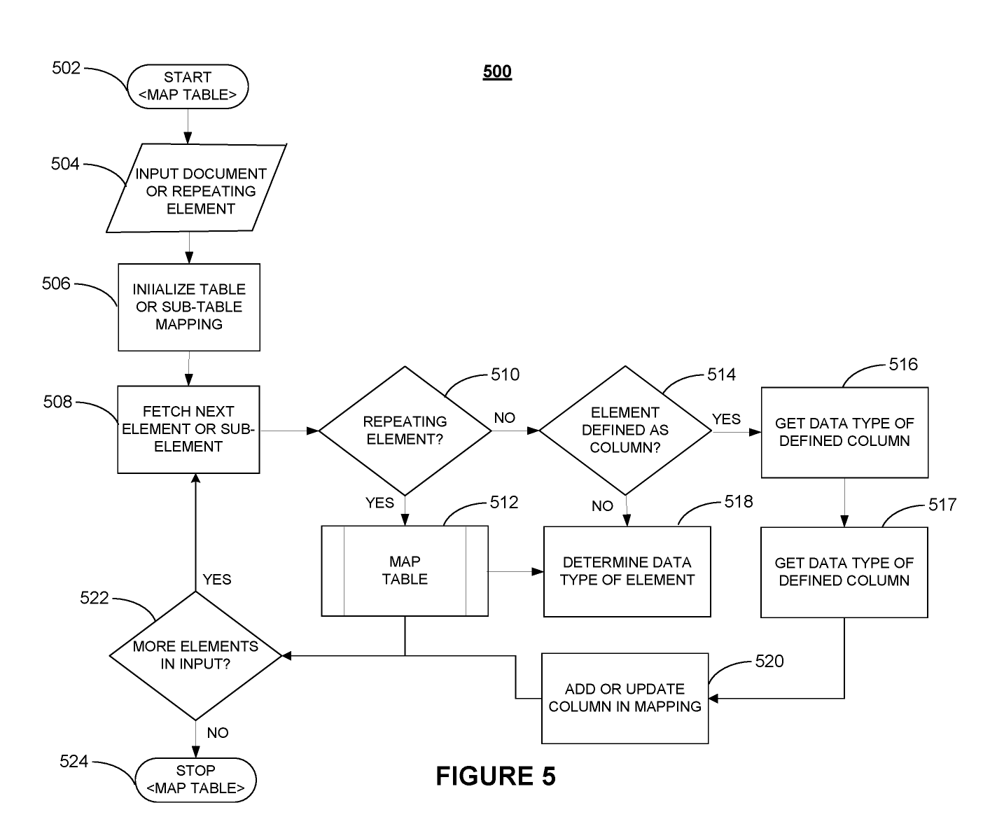

FIG. 4 and FIG. 5 are flowcharts of an exemplary process for generating a relational schema that separates repeating elements into their own tables, according to various embodiments of the present disclosure. The term “element” as used herein refers to attributes, fields, arrays, or sets, as related sub-tables. This is in stark contrast to existing designs that model a document simply as a single table to avoid the complexity of normalizing the data mapping.

FIG. 4 illustrates the recursive mapping of documents in a non-relational document database to a model. The process starts at step 402 by reading iteratively through the sampled documents. At step 404, the first sampled document is fetched and, at step 406, a predefined Map Table procedure is called. Once there are no documents left to sample, the process ends at step 410.

FIG. 5 illustrates the recursive portion 406 of the process in FIG. 4. Once a document or repeating element is input at step 504, the data model is initialized with a first table, at step 506, since at least one table is used to model documents in a document collection. Then, at step 508, the process starts reading iteratively by fetching an element (or sub-element) to determine whether the element is a repeating sub-element, such as AvailableProducts and Sales in FIG. 1, if so, step Map Table 512 is recursively called to model embedded repeating sub-elements and generate a related sub-tables in what may be viewed as a nested sub-process that allows for any arbitrary number of levels of repeating values. Otherwise, for example if the element is a single-value field such as SalespersonId and StartDate in FIG. 1, it is determined, at step 514, whether the element is defined as a column. If it is not so defined, then the process determines the data type, at step 516, and adds, at step 520, a column to the table with the appropriate data type. Conversely, if it is defined, e.g., by a previous document, the data type is determined, at step 518, and the column is updated, at step 520. At step 522, the process determines whether there are more elements in the input and, if so, the process returns to step 508 and resumes with fetching the next (sub-) element. Else, the recursive portion of the process ends, at step 524.

In other words, the nesting process continues until the created embedded document no longer has its own sub-elements. After processing the first document, the next sample document is fetched and examined for fields and sub-elements, and definitions of already created tables are refined, as subsequent documents may contain additional fields or different data in the same fields. For example, one field may contain a date leading to a date column type, whereas the next documents may contain a text string in that field. In embodiments, the data type for a field may be relaxed from a date type to a text type so as to accommodate values for both data types. Overall, the process produces a relational schema that separates repeating elements into their own tables that relate back to the original top-level table with foreign keys. Examples of the types of schemas that may be generated by different types of MongoDB documents may be found on the Toad World community web site.

In embodiments, the result of this mapping process may be used to create a local table in a centralized repository for sharing files and other data, such as Toad Intelligence Central (TIC), with an associated configuration artifact that defines the mapping from the table to the MongoDB collection. The configuration contains a mapping for a top-level table, and zero or more mappings for sub-tables. Each mapping for both top-level table and sub-tables is defined by 1) a unique name for the table, 2) the name of the MongoDB collection to which the table is mapped, and 3) a set of named columns for the table that are defined by a) a unique name within the table, b) the type of data that will populate the column, and c) a document reference to the element that contains the data for that column.

In embodiments, once the relational schema is generated and the data from the non-relational database is mapped into for example tables, the schema may be used to access a non-relational database and execute a relational query against the tables. For example, a MongoDB database may be accessed, and a SQL query may be executed against a local TIC table. In embodiments, the overall process of TIC executing a query and return MongoDB data may begin with a user submitting a SQL query to TIC that references a table that is mapped to a MongoDB database. TIC may use the table mapping configuration to generate a MongoDB query that will fetch the selected columns, and execute any data manipulation operations that are supported by MongoDB. TIC may then connect to the configured MongoDB database, execute the generated MongoDB query, and retrieve the resulting documents. TIC may generate a tabular result set from the results returned by the MongoDB query, where each returned document is flattened out into a single row of the tabular results. And, finally, the tabular result set may be returned to the user that submitted the SQL query.

It is noted that TIC aims to optimize cross-database queries. A fundamental precept of such optimization is to minimize the amount of data that is transferred over the network from external databases to the TIC server during the execution of a query. In practice, this involves pushing out as much data manipulation as possible to the external database where it can be performed most efficiently and closest to the data.

With this in mind, there are three components of interest in a SQL query against a MongoDB-mapped table:

1. The set of columns in the SELECT clause: The size of the documents returned by the MongoDB query can be minimized by specifying that they must contain only the elements of interest to this query—as opposed to all the elements contained in the complete table mapping.

2. Optional filter conditions in the WHERE clause: The count of the documents returned by the MongoDB query can be minimized by creating corresponding MongoDB filters that will exclude all documents that TIC would ultimately exclude from the results anyway.

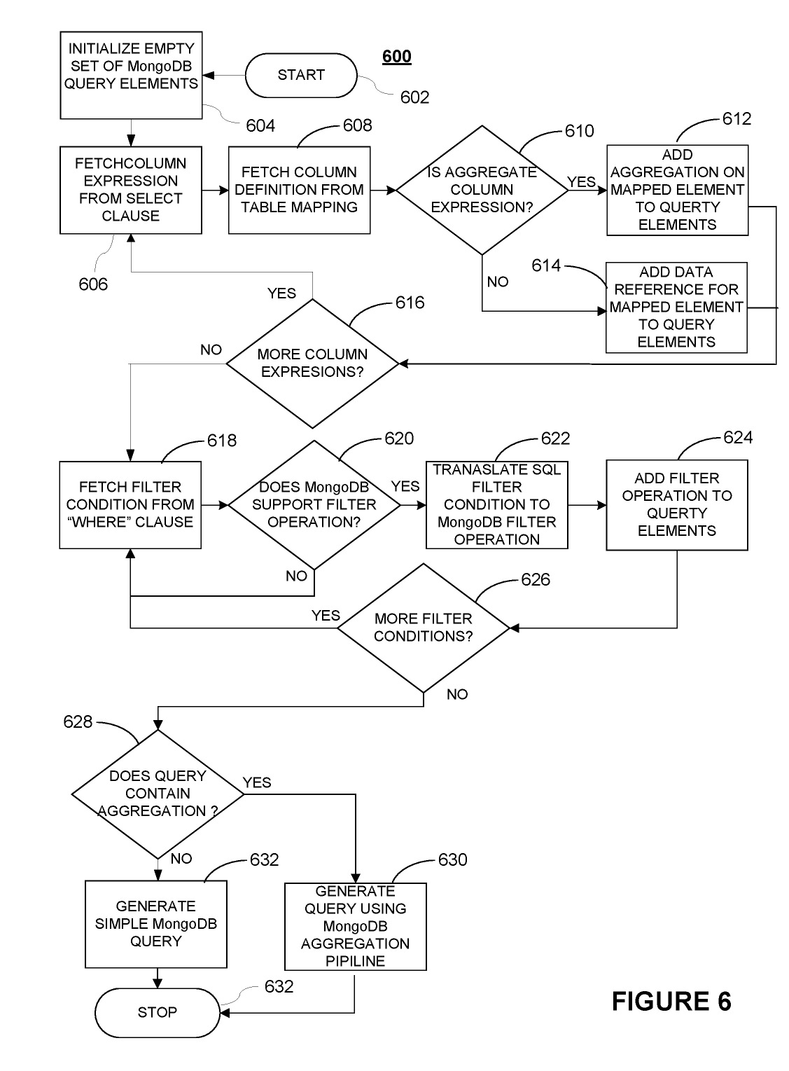

3. Optional aggregation operations such as GROUP BY, SUM, COUNT, etc.: Both the size and count of the documents returned by the MongoDB query can be reduced by having MongoDB to perform these operations and return a summary result set, rather than returning the more voluminous raw data. The process for combining these SQL elements into a MongoDB query is illustrated in FIG. 6.

The final step of executing the user's SQL query is to return a tabular result set. The principle challenge here is that MongoDB will return a set of documents as the results of its query, where the documents may contain nested elements. Therefore, in embodiments, the TIC table mapping is used to flatten these potentially multi-level documents into a two-dimensional table of results. This contrasts with existing designs that return single value fields of top-level document as separate columns, but encode any repeating sub-elements, such as arrays or sets, into a long unreadable string value in a single column.

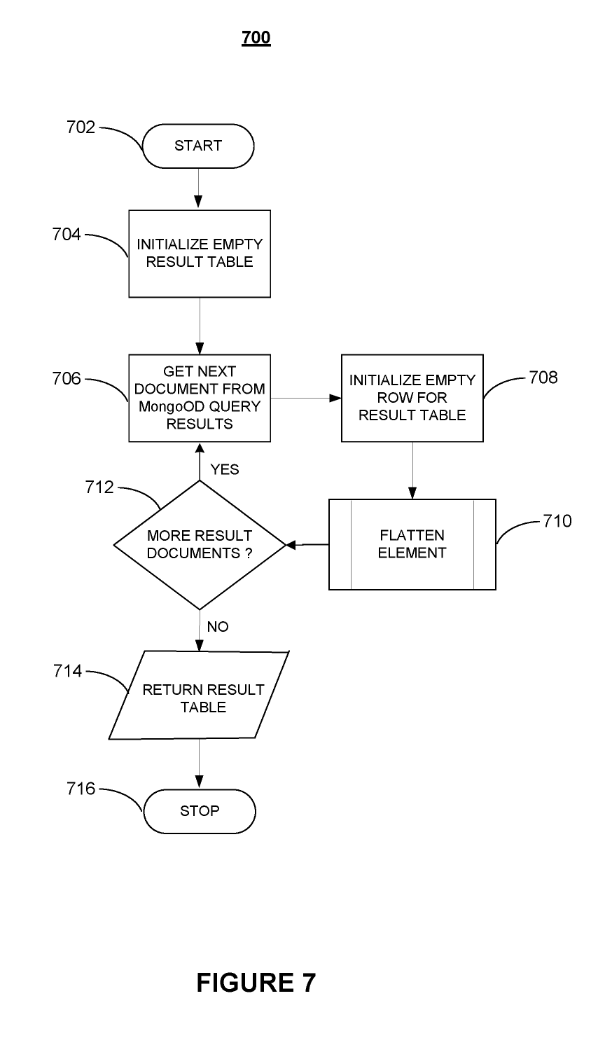

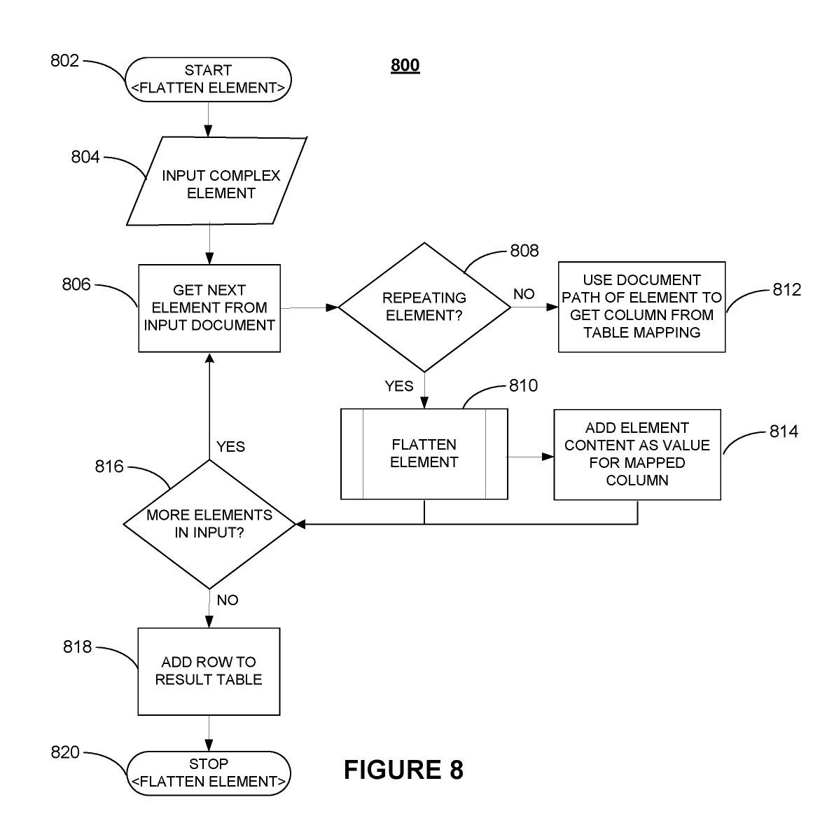

FIG. 7 and FIG. 8 are flowcharts of an illustrative process for tabulating MongoDB result documents, according to various embodiments of the present disclosure. As shown in FIG. 7, predefined process flatten element 710 that flattens repeating elements is recursively called to enable nested levels of repeating elements and, thus, to accommodate arbitrarily deep multi-level nesting. A “repeating element” is any array or set of repeating elements embedded within the document. It is noted that such embedded elements may, in turn, contain their own array or set of repeating sub-elements. FIG. 8 illustrates the recursive portion 710 of the process for flattening documents into a table in FIG. 7. Once the documents resulting from the MongoDB query are flattened into a table of rows and columns, the table is returned as the result set for the SQL query.

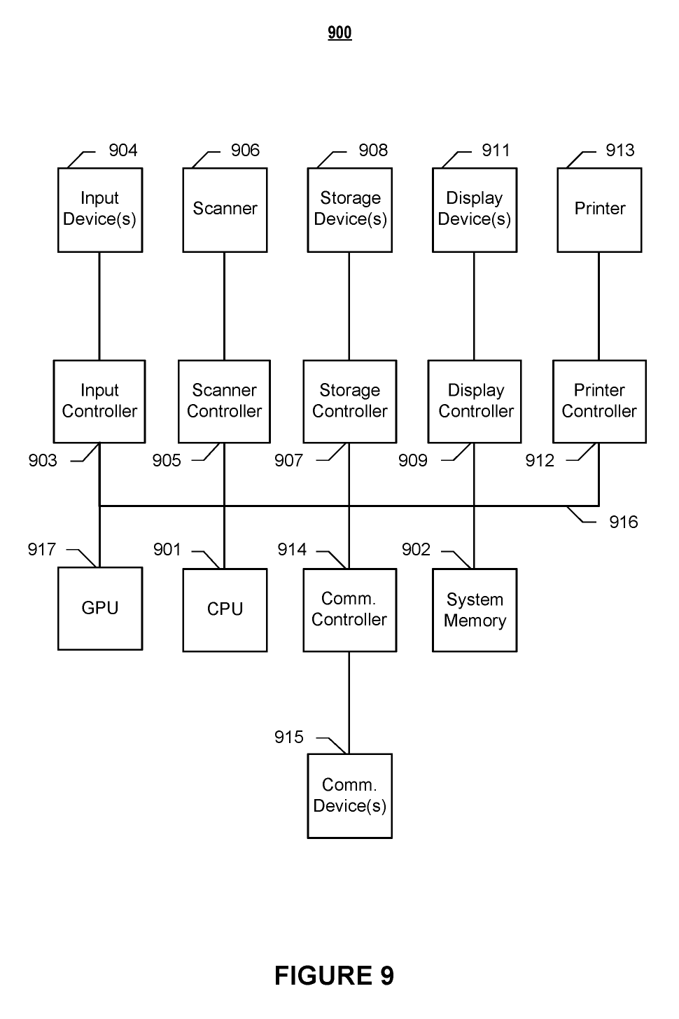

FIG. 9 depicts a block diagram of an exemplary information handling system according to embodiments of the present invention. It will be understood that the functionalities shown for system 900 may operate to support various embodiments of an information handling system—although it shall be understood that an information handling system may be differently configured and include different components. As illustrated in FIG. 9, system 900 includes a central processing unit (CPU) 901 that provides computing resources and controls the computer. CPU 901 may be implemented with a microprocessor or the like, and may also include a graphics processor and/or a floating point coprocessor for mathematical computations. System 900 may also include a system memory 902, which may be in the form of random-access memory (RAM) and read-only memory (ROM).

A number of controllers and peripheral devices may also be provided, as shown in FIG. 9. An input controller 903 represents an interface to various input device(s) 904, such as a keyboard, mouse, or stylus. There may also be a scanner controller 905, which communicates with a scanner 906. System 900 may also include a storage controller 907 for interfacing with one or more storage devices 908 each of which includes a storage medium such as magnetic tape or disk, or an optical medium that might be used to record programs of instructions for operating systems, utilities and applications which may include embodiments of programs that implement various aspects of the present invention. Storage device(s) 908 may also be used to store processed data or data to be processed in accordance with the invention. System 900 may also include a display controller 909 for providing an interface to a display device 911, which may be a cathode ray tube (CRT), a thin film transistor (TFT) display, or other type of display. The computing system 900 may also include a printer controller 912 for communicating with a printer 913. A communications controller 914 may interface with one or more communication devices 915, which enables system 900 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

We claim:

1. A system to generate a relational data model from a non-relational document database, the system comprising:
at least one processor;
a non-transitory computer-readable medium or media comprising one or more sequences of instructions which, when executed by the at least one processor, causes steps to be performed comprising:
sampling a set of documents from the non-relational document database, one or more of the documents in the set of documents comprising semi-structured document data;
generating a schema for items contained within a set of documents, the schema maps the semi-structured document data into a relational data structure; and
using Structured Query Language to query at least one of a relational and a non-relational database.

2. The system according to claim 1, wherein the schema merges multi-level target structures of relational data that are generated from at least the non-relational document database.

3. The system according to claim 2, wherein the merged schema is generated by forming aggregates that represent at least the sampled set of documents.

4. The system according to claim 1, further comprising storing the schema as a configuration in a normalized tabular format.

5. The system according to claim 1, wherein generating the schema comprises the steps of:
sampling, parsing, and analyzing the set of documents to identify non-repeating elements and repeating elements;
generating a multi-level target structure that separates the repeating elements into individual structures that comprise no repeating elements; and
using foreign keys to associate individual structures with at least a single-level target structure.

6. The system according to claim 5, further comprising, for a non-repeating element that is not defined in column format, determining a data type and updating or adding a column to the single-level target structure.

7. The system according to claim 5, wherein the multi-level target structure comprises relational tables that comprise sub-tables for the repeating elements.

8. The system according to claim 7, further comprising recursively generating the sub-tables via a control loop.

9. The system according to claim 7, wherein the relational tables form a group of relational SQL tables that can be queried using regular SQL statements.

10. The system according to claim 5, wherein the multi-level target structure conforms to guidelines for First Normal Form.

11. A system to access documents in a non-relational document database by using a schema and a relational database query, the system comprising a database engine that performs the steps of:
in response to receiving the relational database query, using a schema to generate a non-relational document database query that is equivalent to the relational database query;
accessing a non-relational document database to execute the non-relational document database query and obtain data elements;
using the schema to format at least the data elements as two-dimensional tabular data; and
outputting the two-dimensional tabular data as a relational database query result.

12. The system according to claim 11, wherein the data elements are placed in a single row of a two-dimensional table.

13. The system according to claim 11, wherein generating comprises mapping names of elements in the non-relational document database to columns.

14. The system according to claim 11, wherein executing the non-relational document database query comprises applying one or more data manipulation methods that reduce an amount of data elements received from the non-relational document database.

15. The system according to claim 14, wherein the one or more data manipulation methods comprise applying at least one of a filtering condition and data aggregation.

16. A system to generate, from documents sampled from a non-relational document database, a relational data model that collectively describes the sampled documents, the system comprising a database engine that performs the steps of:
obtaining a document from the non-relational document database, the document comprising semi-structured document data;
analyzing the document for fields and sub-documents to identify non-repeating elements and repeating elements;
generating a schema that maps the semi-structured document data into a relational data structure that comprises a top-level relational table for non-repeating elements by separating a repeating element into a sub-table that relates back to the top-level table via at least a foreign key, such that the sub-table comprises no repeating element; and
using Structured Query Language to query at least one of a relational and a non-relational database.

17. The system according to claim 16, wherein the non-relational document database is sampled in batches to create a chronological diverse spread of documents over evolving document formats.

18. The system according to claim 16, wherein the step of analyzing the document is automated.

19. The system according to claim 18, wherein, based on a result if analyzing the document, the database engine formats the document as tabular data.

20. The system according to claim 16, wherein at least one of the table and the sub-table comprises a set of named columns that comprise unique names, the names being defined by a type of data and a document reference to the element that contains data for one of the set of named columns.
